(19) United States
(12) Patent Application Publication
(10) Pub. No.: US 2025/0222400 A1
(43) Pub. Date: Jul. 10, 2025

(54) PROCESS FOR STABILIZING NUTRIENTS IN A DISCHARGED ANAEROBIC DIGESTATE

(71) Applicant: ThioSolv, LLC, Largo, FL (US)

(72) Inventors: Michael J. Ray, Clearwater, FL (US); Michael F. Ray, Clearwater, FL (US)

(21) Appl. No.: 18/990,514

(22) Filed: Dec. 20, 2024

Related U.S. Application Data
(60) Provisional application No. 63/617,845, filed on Jan. 5, 2024.

(51) Int. Cl. B01D 53/78; B01D 53/52; B01D 53/58; C01B 17/64; C01C 1/22

(52) U.S. Cl. CPC B01D 53/78; B01D 53/52; B01D 53/58; C01B 17/64; C01C 1/22; B01D 2251/206; B01D 2251/508; B01D 2257/304; B01D 2257/406; B01D 2258/05

(57) ABSTRACT

A process for stabilizing nutrients in anaerobic digestate involves removing hydrogen sulfide and ammonia from biogas. This process involves circulating the digestate in a column and contacting it with the biogas. Additional ammonium bisulfite, ammonia, and/or sulfur dioxide may be added to the contacting device to remove hydrogen sulfide from the biogas. The reactions will create ammonium bisulfite, ammonium sulfite, and ammonium thiosulfate to prevent ammonia and hydrogen sulfide emissions to allow for land application.

### CROSS-REFERENCE TO RELATED APPLICATION

This application claims priority from U.S. Provisional Patent Application No. 63/617,845 filed on Jan. 5, 2024, the entire disclosure of which is part of the disclosure of the present application and is hereby incorporated by reference in its entirety.

### BACKGROUND

In an effort to reduce the greenhouse gas emissions that originate from animal excrement and organic waste, anaerobic digesters are commonly employed to produce a natural gas that can be used as a fuel source. This natural gas, commonly referred to as biogas, is produced by microorganisms during the anaerobic digestion of organic matter. Biogas typically contains, but is not limited to, carbon dioxide, methane, ammonia, and hydrogen sulfide. Hydrogen sulfide is a highly toxic and corrosive gas that can be lethal to humans even at low exposure limits. Hydrogen sulfide in biogas, when present in higher amounts than is permitted by environmental regulators, must be removed by downstream processes. Similarly, ammonia is harmful at elevated levels and requires additional processing or removal prior to the recycling or storage of the anaerobic digestate.

Depending on the pH of the anaerobic digestate, residual amounts of ammonia or hydrogen sulfide may be entrained in the solution. When used as a fertilizer, these gases may be uncontrollably released when applied to the soil, during blending with other components before application to the soil, upon contact with low pH materials in the soil, or during mixing with more acidic or basic solutions. The uncontrolled release of ammonia and hydrogen sulfide may cause serious harm to farmers, agricultural workers, or other individuals in the vicinity. Therefore, there is a need for a process that allows the anaerobic digestate to be discharged and land applied in a safe manner and that allows the nutrients to remain in the solution.

### SUMMARY

A process for stabilizing the nutrients in a discharged anaerobic digestate involves removing hydrogen sulfide and ammonia from biogas by contacting the biogas and the anaerobic digestate and injecting sulfur dioxide into the digestate.

In one or more embodiments, anaerobic digestate from a digester is allowed to contact biogas in a absorption column such that the biogas leaving the column has a substantially lower concentration of ammonia and hydrogen sulfide. Additional ammonium bisulfite and/or ammonia along with sulfur dioxide can be added to fortify the concentration of ammonium bisulfite produced to help remove more hydrogen sulfide. The stabilization process involves reacting the sulfur dioxide with the ammonia and the hydrogen sulfide to form ammonium bisulfite, ammonium sulfite, and ammonium thiosulfate. Advantageously, the stabilized anaerobic digestate can be used and sold as an agricultural fertilizer.

### BRIEF DESCRIPTION OF THE DRAWING

The invention will be described in detail below with reference to the attached drawings which describe or relate to an apparatus and methods for the present invention.

FIG. 1 illustrates a schematic diagram of an exemplary system for stabilizing nutrients in an anaerobic digestate by removing ammonia and hydrogen sulfide from the biogas.

### DETAILED DESCRIPTION OF THE INVENTION

Depending on the context, all references below to the “invention” may in some cases refer to certain specific embodiments only. In other cases, it will be recognized that references to the “invention” will refer to subject matter recited in one or more, but not necessarily all, of the claims.

When describing a range of pHs, concentrations and the like, it is the Applicant's intent to disclose every individual number that such a range could reasonably encompass, for example, every individual number that has at least one more significant figure than in the disclosed end points of the range. As an example, when referring to a pH as between about 4.5 and 8.5, it is intended to disclose that the pH can be 4.5, 8.5 or any value between these values, including any subranges or combinations of subranges encompassed in this broader range. Applicant's intent is that these two methods of describing the range are interchangeable. Moreover, when a range of values is disclosed or claimed, Applicant also intends for the disclosure of a range to reflect, and be interchangeable with, disclosing any and all sub-ranges and combinations of sub-ranges encompassed therein. Accordingly, Applicant reserves the right to proviso out or exclude any individual members of any such group, including any sub-ranges or combinations of sub-ranges within the group, or any selection, feature, or aspect that can be claimed, if for any reason Applicant chooses to claim less than the full measure of the disclosure, for example, to account for a reference that Applicant may be unaware of at the time of the filing of the application. In particular, the ranges set forth herein include their endpoints unless expressly stated otherwise.

The term “about” means that pH and other parameters and characteristics are not and need not be exact, but may be approximate and/or larger or smaller, as desired, reflecting tolerances, conversion factors, rounding off, measurement error and the like, and other factors known to those of skill in the art. An amount, size, formulation, parameter or other quantity or characteristic is “about” or “approximate” whether or not expressly stated to be such. Whether or not modified by the term “about”, the claims include equivalents to the values stated therein.

Furthermore, the particular illustrative embodiments disclosed herein may be altered or modified and all such variations are considered within the scope and spirit of the present invention. While process is described in terms of “comprising,” “containing,” or “including” various devices/components or steps, it is understood that the process also can “consist essentially of” or “consist of” the various components and steps.

As used herein, the terms “column” and “contact zone” can include any combination of towers, columns, absorption columns, reactors, trays, venturis, static mixers, vessels, pumps, valves, control systems, and any other equipment known in the art useful in contacting liquids and gases.

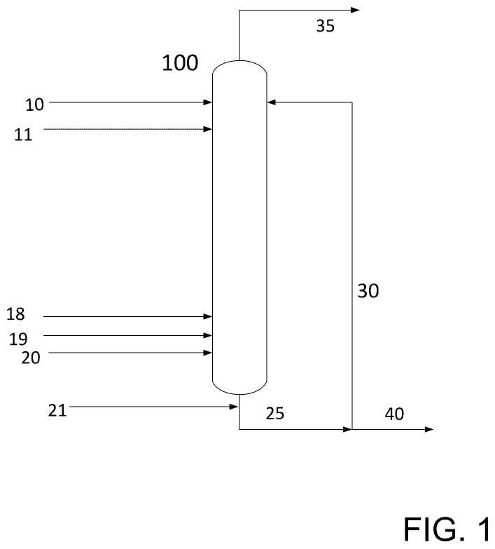

As illustrated in FIG. 1, a first Process Stream 10 containing a digestate from an anaerobic digester (not shown) is introduced to Column 100 where it is contacted with biogas (which can also be produced in the anaerobic digester) contained in a second Process Stream 20. When the biogas passes through the circulating digestate solution from Stream 10 in Column 100, ammonia and hydrogen sulfide are entrained in the liquid and removed from the treated biogas. In addition, a liquid solution containing ammonium bisulfite and/or ammonium sulfite can be added through Stream 11 (into Column 100) or Stream 21 (to the effluent from Column 100) to lower the pH and subsequently enable the absorption of more hydrogen sulfide. Ammonia, in gaseous or aqueous form, can be added via Stream 19 to balance the reaction stoichiometry. Sulfur dioxide can also be added through Stream 18 to remove excess ammonia and to produce addition ammonium bisulfite and ammonium thiosulfate. The treated biogas exits as Stream 35 from the top of Column 100 while a liquid anaerobic digestate effluent exits via Stream 25 from the bottom of Column 100.

In one embodiment, a portion of the effluent (stream 25) can be circulated back to Column 100 as stream 30.

The following equations show the production of ammonium bisulfite, ammonium sulfite, and ammonium thiosulfate:

NH₃+SO₂+H₂O↔NH₄HSO₃ (Ammonium Bisulfite)

2NH₃+SO₂+H₂O↔(NH₄)₂SO₃ (Ammonium Sulfite)

6NH₃+4SO₂+2H₂S+H₂O↔3(NH₄)₂S₂O₃ (Ammonium Thiosulfate)

The volatility of the ammonia in the anaerobic digestate effluent is reduced through the sulfur dioxide addition resulting in a lowering of the pH of the solution. That is, the ammonia is less likely to leave the system since the pH is lower and most of the ammonia is being consumed during the production of ammonium bisulfite and ammonium thiosulfate.

The effluent leaving as stream 40 is stabilized and has minimal ammonia emissions and no hydrogen sulfide emissions, since the hydrogen sulfide in the anaerobic digestate effluent is reacted to create ammonium thiosulfate. The treated anaerobic digestate/stabilized effluent can be used as a fertilizer.

In one or more embodiments of this process, the addition of ammonia and sulfur dioxide is proportionally controlled using the pH of Stream 25 as a variable. A higher pH would assume more ammonia is in the system which will lead to more sulfur dioxide being added. There are other methods of monitoring the ammonia contained in the digestate that can be utilized rather than relying on pH alone.

The description presents several preferred embodiments of the present invention in sufficient detail such that those skilled in the art can make and use the invention. As used herein, the words “comprise,” “have,” “include,” and all grammatical variations thereof are each intended to have an open, non-limiting meaning that does not exclude additional elements or steps.

Therefore, the present invention is well adapted to attain the ends and advantages mentioned as well as those that are inherent therein. The one or more embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

1. A process for stabilizing the nutrients in anaerobic digestate and biogas, comprising:
(i) contacting the biogas and the anaerobic digestate in a contact device to substantially remove hydrogen sulfide and ammonia contained in the biogas; and
(ii) producing an anaerobic digestate effluent having entrained substantially all the hydrogen sulfide and ammonia from the biogas.

2. The process according to claim 1, further comprising injecting sulfur dioxide into the contact device, wherein residual ammonia in the anaerobic digestate effluent reacts with the sulfur dioxide to produce ammonium sulfite and ammonium bisulfite.

3. The process according to claim 2, wherein the ammonium bisulfite further reacts with residual hydrogen sulfide in the anaerobic digestate effluent to produce ammonium thiosulfate.

4. The process according to claim 1, wherein the pH in the contact device is maintained between 5.5 and 8.5.

5. The process according to claim 4, wherein the pH in the contact device is maintained between 6.0 and 7.5.

6. The process according to claim 4, wherein the pH is adjusted through the addition of ammonia and sulfur dioxide.

7. The process according to claim 4, wherein the pH is adjusted through the addition of ammonium sulfite, ammonium bisulfite, and ammonia.

8. The process according to claim 1, further comprising lowering the volatility of the ammonia in the anaerobic digestate effluent through adding sulfur dioxide to lower the pH of the solution.

9. The process according to claim 2, further comprising substantially eliminating the hydrogen sulfide in the anaerobic digestate effluent through the reaction with ammonium sulfite and ammonium bisulfite to produce ammonium thiosulfate.

10. The process according to claim 2, further comprising adding additional ammonium sulfite and/or ammonium bisulfite to the contact device.

11. The process according to claim 3, further comprising adding additional ammonia to the contact device.

12. The process according to claim 8, further comprising adding additional ammonia to the contact device.

13. The process according to claim 8, further comprising adding additional sulfur dioxide to the contact device.
